(19) United States
(12) Patent Application Publication
(10) Pub. No.: US 2004/0023611 A1
(43) Pub. Date: Feb. 5, 2004

(54) Method and device for producing sausages

(76) Inventor: Nicolaas Cornelis Van Der Post, Gouderak (NL)

Correspondence Address: Webb Ziesenheim Bruening Logsdon, Orkin & Hanson, 700 Koppers Building, 436 Seventh Avenue, Pittsburgh, PA, 15219-1818, US

(21) Appl. No.: 10/296,279

(22) PCT Filed: May 22, 2001
(86) PCT No.: PCT/NL01/00391

(30) Foreign Application Priority Data
May 22, 2000 (NL) 1015256

(51) Int. Cl. A22C 11/00

(52) U.S. Cl. 452/30

(57) ABSTRACT

The present invention relates to a method and a device for producing a food product, in particular sausages, in which the food product is produced using co-extrusion, the core being formed from an edible material, such as meat, which is covered on the outer side with a casing, in particular a protein casing, wherein the food product is then passed to a climate chamber on a support of a conveyor chain, and the point of contact between this support and the food product is changed continuously or periodically.

The invention relates to a method and a device for producing a food product, in particular sausages.

In the present text, the term “food product” is understood as meaning all food products which can be produced by the extrusion process. In particular, the term refers to sausages which are produced using a co-extrusion process.

Various methods of making sausages are known in the prior art. A first method for making a sausage is known as fermentation. In this method, a sausage is fermented and dried in a climate chamber. The drying generally takes a number of days. The result is what is known as “dry” sausage. Cervelat, for example, is produced in this way. Furthermore, it is known to make sausages by means of a pasteurizer. A raw meat product is boiled until it is cooked in the pasteurizer at a relatively high temperature. The result is cooked sausage.

Making dry sausage is a totally different skill from making cooked sausage. Furthermore, the device for making dry sausage differs considerably from the device for making cooked sausage. In view of the difference in production rate, the logistics for making one type differ considerably from the logistics for making the other type in a sausage factory. Therefore, it is customary in the prior art for sausage producers to make either dry sausage or cooked sausage.

Intestines are in widespread use for the production of dry sausages. The intestine is filled with a meat product. After it has been filled, the intestine is pinched or folded shut. The distance between two constrictions defines the length of the sausage which is produced. The intestine is not cut through when it is being squeezed shut. This means that the succession of sausages are attached to one another by means of the intestine. In this way, the sausages form strings of sausages. As an alternative, an intestine is used to produce separate sausages. In this case, a piece of string is attached to one end of a separate sausage of this type with the aid of an iron clamp. This is also known as clipping the sausage. of the receptacles. As a result of the sausages being rolled in the receptacles, in each case a different part of the circumference of the sausages is in contact with the material of the receptacles 40. This means that the sausages 7 are exposed to the ambient air all the way around and can therefor dry uniformly.

The object of the present invention is to provide a method and a device of the type described in the preamble which can be used to make both dry sausages and cooked sausage.

In the present invention, this object is achieved by the fact that in a first step, a food product is produced with the aid of co-extrusion, the core being formed from an edible material, such as meat, which is covered on the outer side with a casing, in particular a protein casing, then, in a second step, the food product is passed to a predrying chamber, for the purpose of predrying the food product in this predrying chamber, and, in a third step, the food product is passed, with the aid of conveyor means, to a climate chamber, for the purpose of fermenting and drying the said food product in this climate chamber, or, in the third step, the food product is passed to a boiling installation for cooking the food product, the food product being passed through the first, second and third steps on a support, and the point of contact between this support and the food product being changed continuously or periodically.

According to the invention, there is provision for co-extrusion to be used for the starting product whether for a cooked sausage or for a dry sausage. After the co-extrusion, the sausage is then passed through a predrying chamber. In this chamber, at least the wall of the sausage will dry out to some extent. It is then possible to choose either to ferment and dry the sausage or to boil the sausage.

Since the point of contact between the sausage and the support changes continuously, the sausage is prevented from sticking to the support during the drying or boiling.

According to the invention, it is possible for the food product in the said climate chamber to be dried at a temperature of 20 to 30° C., in particular 25° C. In this context, it is advantageous for the temperature in the climate chamber to be reduced, during drying, from a temperature of 20 to 30° C., in particular 25° C., to a final temperature of 10 to 20° C., in particular 12° C.

Furthermore, according to the invention, it is advantageous if the temperature in the set at 85%-95%, in particular 90%. Furthermore, it is possible for the relative atmospheric humidity in the said climate chamber to be reduced from an initial level of 85%-95%, in particular 90%, to a final level of 70%.

According to the invention, it is advantageous for the relative atmospheric humidity in the climate chamber to be reduced by 5% every 24 hours.

The individual sausages cannot be hung in the climate chamber. Therefore, the sausages are passed to the climate chamber where they are positioned on a support. This support has to be designed in such a way that the sausages can be held on the support.

According to the invention, it is possible for the food product to be moved in the climate chamber with the aid of the support, in which case the food product is preferably guided through substantially the entire climate space.

In order to be able to dry the sausages uniformly, it is important for the climate conditions to be identical for all the sausages in the climate chamber. Particularly when using large climate spaces, it is almost inevitable that, in use, there will be differences in climate between different positions in the chamber. To prevent products in the climate chamber from being exposed to different climate conditions, it is possible, according to the invention, for the products to be conveyed uniformly through the climate chamber. If all the products in the climate chamber are guided through the chamber, preferably through substantially the entire space, the products are exposed substantially to identical climate conditions.

According to the invention, it is advantageous for the food product to be cooked, in a second step, at a temperature of 70-80° C.

Furthermore, it is possible for the food product, after the first step and before the second step, to be treated with liquid smoke.

forming a food product, such as a sausage, with a core of edible material, such as meat, which is covered on the outer side with a casing, in particular a protein casing.

According to the invention, the co-extrusion device adjoins a first endless conveyor for conveying the food product, such as the sausage, through a predrying chamber, which first conveyor adjoins both a second endless conveyor for conveying the food product to a climate chamber for further drying the food product, in this climate chamber, and a third endless conveyor, for transporting the food product through a boiling device, such as a pasteurizer, for cooking the food product, the device comprising means for passing the food product from the first conveyor to either the second or third conveyor as desired.

The device according to the invention can be used to produce both dry sausages and boiled sausages. After they have passed through the predrying stage in the predrying chamber, the sausages are either passed onwards towards the boiling device, such as a pasteurizer, or are passed onwards towards a climate chamber.

To be able to set up the device according to the invention even more efficiently, it is furthermore possible, as an alternative, for the co-extrusion device also to adjoin a fourth conveyor for conveying the food product directly from the co-extrusion device to the climate chamber.

With the aid of this fourth conveyor, it is possible to pass a sausage directly from the co-extruder to the climate chamber. The predrying of the sausage is important in particular when making boiled sausage. However, the predrying chamber is relatively expensive. There are types of dry sausage for which the predrying stage can be skipped. In this case, it is possible for sausages to be passed from a first co-extrusion device to a predrying chamber and from this predrying chamber to either the boiling installation or the climate chamber. A second co-extrusion device can be used to simultaneously or alternately feed sausage to the climate chambers. In this way, the climate chambers are optimally utilized in combination with a relatively small, and therefore advantageous, predrying chamber.

According the invention, it is also possible for the second and/or fourth conveyor(s) to adjoin a fifth conveyor, for conveying the food product through the climate chamber.

In this case, it is possible for the fifth conveyor to comprise substantially horizontally positioned supports for receiving the food product.

According to the invention, it is possible for the supports to be designed as receptacles which are open at the top in order to receive the food product.

To allow good contact between the products on the supports and the ambient air in the climate chamber, it is advantageous for the walls of the supports to be provided with ventilation openings. These openings can be obtained by producing the supports from mesh material.

A climate chamber is generally rectangular in cross section. According to the invention, the space in the climate chamber is optimally utilized by the conveyor describing a path which comprises a number of parallel, substantially horizontally oriented parts and at least one vertically oriented section. By making the length of the clime chamber significantly greater than its height, it is possible to limit the number of horizontal paths and therefore the number of connections between the paths positioned above one another. The ends of the path of the conveyor can advantageously be used to fill (load) and empty (unload) the supports.

Furthermore, it is possible for the ends of the horizontal parts to be connected via a curved section to a horizontal part which lies below.

It is advantageous for the supports to be rotatably connected to the conveyor. In this case, it is preferable for the supports to be able to rotate about an equilibrium position via a positive and a negative angular displacement, respectively leading to a first limit position and a second limit position.

sausage will always have a certain contact area with the support Rotating the sausages leads to this contact area being exposed. Consequently, the exposed contact area comes into contact with ambient air again and can thus be dried.

To ensure that the supports actually rotate, it is possible for the supports to be provided with a cam, stops being arranged adjacent to the horizontal parts of the path of the conveyor in order to engage on the cam of the supports.

In this case, it is possible for the stops to be designed in such a way that the cams of the supports, in the curved part of the path of the conveyor, are free from contact with the stops. At each curved part, the supports come free again. Depending on the direction of movement of the conveyor on the horizontal part lying downstream of the curved part, the support, when it begins its path on the horizontal part, is forced either into its first position or into its second position.

According to the invention, it is also possible for at least one of the supports to adjoin a feed, for feeding the product to the supports. In this case, it is possible for the feed to comprise a conveyor belt, the conveyor belt being guided, over at least part of its length, past a ram member for moving the product on the conveyor belt in a direction which is perpendicular to the direction of movement of this conveyor belt.

A first and a second ram device may be provided in the device. In this case, the first ram device is positioned upstream of the transition between the feed and the supports. The supports are of a defined length, so that the number of sausages per support is limited. A sensor can be used to establish whether the correct quantity of sausages has been supplied towards a support This sensor is connected to the ram member, in order to be able to restrict the size of a group of sausages which is supplied.

The second ram member is arranged parallel to the supports. This ram member is used to push a group of sausages off the conveyor belt into a support.

The present invention will be described in more detail on the basis of the appended drawings in which:

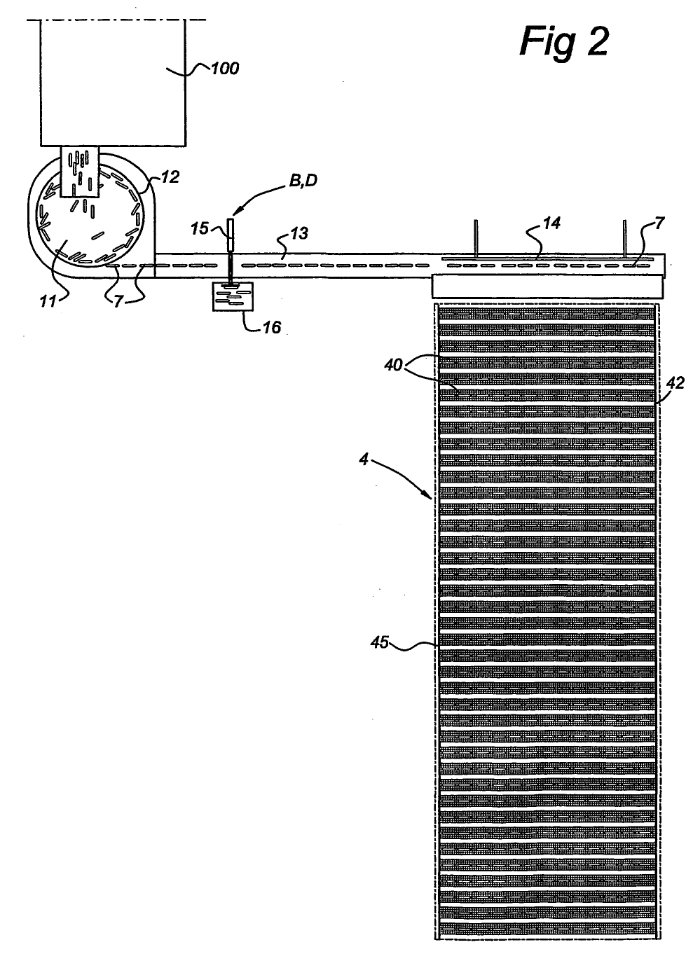

FIG. 2 shows a plan view of that section of the device which is used to dry sausage in a climate chamber.

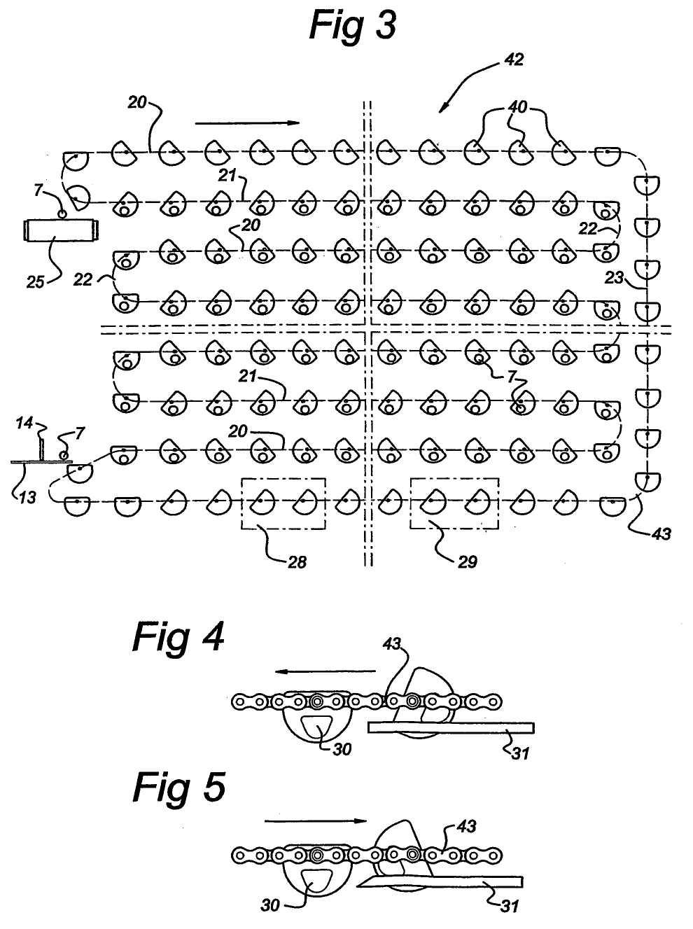

FIG. 3 shows a side view of the fifth conveyor device, in the climate chamber according to the invention.

FIG. 4 shows a support in a first limit position.

FIG. 5 shows a support in a second limit position

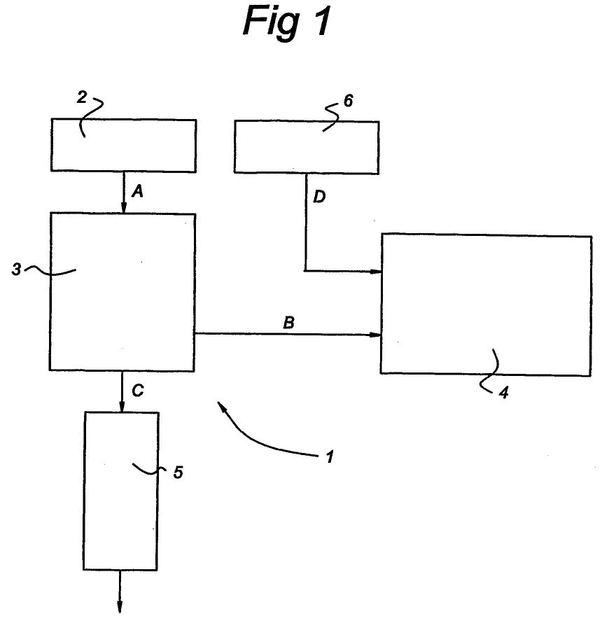

FIG. 1 illustrates a diagrammatic plan view of the device 1 according to the invention The device 1 comprises a device 2 for making sausage 7. This device 2 comprises at least one co-extrusion device for forming a core from an edible material, such as meat, which is covered on the outer side with a casing, in particular a protein casing. From the device 2 the sausage is fed to a predrying chamber 3, via the feed route A. The sausage is conveyed with the aid of an endless conveyor, which may be designed as a chain.

From the predrying chamber 3, the sausage is conveyed onwards, optionally via route B, to the climate chamber 4. In this climate chamber, the sausage is fermented and dried for a number of days. During the fermenting, both the temperature and the atmospheric humidity in the chamber are accurately controlled.

The way in which the climate chamber 4 operates will be explained extensively with reference to FIG. 2 et seq.

Alternatively, a sausage 7 is conveyed from predrying chamber 3 to the pasteurizer 5, where the sausage is boiled until it is cooked within a few hours, for example 3 hours, at a relatively high temperature of 70-80° C.

The sausages are packaged before entering the pasteurizer 5. The sausage is then boiled in the packaging.

Boiled sausage is often sold in a horseshoe shape. This horseshoe shape is imparted to the sausage before the sausage has been boiled while the sausage is relatively flexible.

FIG. 1 shows that the device 1 can be used as one option to make boiled sausage by allowing the sausage to pass through the device from the co-extrusion (2) via the predrying stage (3) and the boiling stage.

The same device 1 can also be used to make boiled sausage by passing the sausage, after the co-extrusion (2) and the predrying stage (3), to the climate chamber (4). FIG. 1 also shows that the device comprises a second co-extrusion device which is directly connected, via a conveyor D, to the climate chamber (4). The way in which this climate chamber 4 works is described in more detail with reference to FIGS. 2-5.

FIG. 2 shows a plan view of the climate chamber 4, with a conveyor device 13 for passing sausage 7 to the climate chamber 4. The walls of the climate chamber are diagrammatically denoted by the reference numeral 45. In FIG. 2, the sausages are passed to the climate chamber 4 in a stepwise manner. The sausages 7 are produced via co-extrusion using a device 2 or 6 as shown in FIG. 1. In FIG. 2, the preliminary section of production of the sausages and the optional predrying is denoted by reference number 100.

The sausages 7 are passed to a drum 11. The rotation of the drum causes the sausages 7 to be pressed onto the wall 12, so that the sausages 7 come to lie in line with one another. The sausages 7 are then removed from the drum with the aid of a conveyor belt 13. The sausages 7 lie one behind the other on conveyor belt 13 and, in this configuration, are passed to the climate chamber 4.

In the vicinity of the end of the conveyor belt 13, the sausages 7 are pushed into the receptacles 40 with the aid of a slide 14. The number of sausages 7 that fit into the receptacles each time is dependent on the length of each of the sausages. To prevent too many sausages from lying in front of the slide 14, a ram 15 is present upstream of the slide 14. A sensor (not shown) is used to check whether the correct number of sausages are moving towards the slide 14, and if the row of sausages is too long, the row of sausages is brought to the correct size with the aid of the ram 15. At the location of the ram 15 there is a collection receptacle 16 for collecting the sausages 7 which have been

FIG. 3 shows a side view of the climate chamber 4 according to the invention. FIG. 3 illustrates the path which is described by a conveyor device 42. The path has a number of horizontal parts 20, 21. Each of the horizontal parts 20, 21 is connected, via a curved section 22, to a section 20, 21 which lies below. On one side (the right-hand side in FIG. 3), the top horizontal part is connected, via a vertical section 23, to the bottom horizontal part. The dimensions of the climate chamber 4 and the conveyor device 42 are adapted to one another in such a way that the conveyor device 42 substantially fills the climate chamber 4. When the chain 43 is driven (cf. also FIG. 4), the receptacles 40 mounted on the chain 43 move along the movement path of the chain. This means that the receptacles 40 are moved through substantially the entire climate space. Should there be any differences in climate between different areas in the climate chamber, these climate differences have an identical influence on all the sausages which are present in the receptacles. The displacement of the receptacles 40 through the space means that every sausage undergoes an identical treatment in the climate chamber.

As has been explained with reference to FIG. 2, the sausages are pushed into the receptacles 40 with the aid of a slide 14. This takes place at a position on the left-hand side of FIG. 3. To enable the receptacles to be emptied again, the receptacles 40 are attached to the chain 43 in such a manner that they can rotate. The receptacles can be rotated, in order to empty them, by attaching a cam to the receptacles. If desired, this cam runs into a stop which can be positioned in the path of the receptacles 40. The receptacles 40 are emptied onto a further conveyor belt 25, which removes the sausages 7.

The rotation of the receptacles 40 is not used only when emptying the receptacles. It is advantageous if the receptacles 40, during their treatment in the climate chamber, can be rotated through an angle which is sufficiently great to make the sausages roll without them falling out of the receptacles. As a result of the sausages being rolled in the receptacles, in each case a different part of the circumference of the sausages is in contact with the material of the receptacles 40. This means that the sausages 7 are

The receptacles 40 will inevitably become dirty in use. This means that the receptacles 40 have to cleaned with reasonable regularity. For cleaning purposes, the device according to the invention comprises two rinsing stations 28, 29. These rinsing stations are arranged at the bottom section of the path of the receptacles 40. At the first rinsing station, nozzles are used to spray an NaOH solution The liquid is, for example, a 30% NaOH solution. At the second rinsing station 29, the receptacles 4 are then rinsed clean using water. This water is preferably at a high temperature of, for example, 70° C. The high temperature leads to effective cleaning of the receptacles. Moreover, the high temperature makes it easy to evaporate the water which has remained behind on the receptacles. To ensure that the receptacles are dried effectively, the device also has a unit for blow-drying the receptacles. This blowing unit comprises a radial fan which is connected to one or more air sources with the aid of a system of lines.

The cleaning installation is deliberately arranged at the bottom section of the path of the receptacles. The cleaning liquids can be discharged at the bottom of the device. Before the receptacles are guided upwards from the bottom section of the path, the receptacles will be blown completely dry. Therefore, the receptacles cannot leak onto receptacles below.

The way in which the sausages are made to roll in the receptacles 40 is explained with reference to FIGS. 4 and 5. At each end of the receptacles 40 there is a cam 30. This cam 30 is in the shape of a triangle with its point facing downwards. The two sides of the triangle which are directed downwards are able to interact with a guide 31. This guide is arranged directly adjacent to the movement path of the chain 43. When the chain is moved in the direction indicated in FIG. 3, the receptacles 40 will move, in a horizontal staring position, from a curved section 22 towards the guide 31. The front side of the cam then comes into contact with the guide 31, so that the receptacle 40 comes to lie at an angle with respect to the horizontal. This inclined position is referred to in the present description as a “limit position”. As a result of the receptacles rocking to and fro, the sausages in the receptacles will roll to and fro.

The device according to the invention can be used to produce sausages without the sausages having to be touched by hand. This increases hygiene during production. The consumer is the first person who comes into contact with the sausages.

1. Method for producing a food product, in particular sausages, in which, in a first step, a food product is produced with the aid of co-extrusion, the core being formed from an edible material, such as meat, which is covered on the outer side with a casing, in particular a protein casing, then, in a second step, the food product is passed to a predrying chamber, for the purpose of predrying the food product in this predrying chamber, and, in a third step, the food product is passed, with the aid of conveyor means, to a climate chamber, for the purpose of fermenting and drying the food product in this climate chamber, or, in the third step, the food product is passed to a boiling installation for cooking the food product, the food product being passed through the first, second and third steps on a support, and the point of contact between this support and the food product being changed continuously or periodically.

2. Method according to claim 1, characterized in that the food product is fermented in the said climate chamber at a temperature of 20 to 30° C., in particular 25° C.

3. Method according to claim 2, characterized in that during the drying the temperature in the climate chamber is reduced in steps from a temperature of 20 to 30° C., in particular 25° C., to a final temperature of 10 to 20° C., in particular 12° C.

4. Method according to claim 3, characterized in that the temperature in the climate chamber is reduced by an average of 4° C. every 24 hours.

5. Method according to one of the preceding claims, characterized in that the relative atmospheric humidity in the said climate chamber is set at 85%-95%, in particular 90%.

6. Method according to claim 5, characterized in that the relative atmospheric

7. Method according to claim 6, characterized in that the relative atmospheric humidity in the climate chamber is reduced by 5% every 24 hours.

8. Method according to one of the preceding claims, characterized in that the food product is received in the climate chamber on a support.

9. Method according to claim 8, characterized in that the food product is moved in the climate chamber with the aid of the support.

10. Method according to claim 9, characterized in that the food product is passed through substantially the entire climate space.

11. Method according to claim 1, characterized in that the food product is cooked, in a second step, at a temperature of 70-80° C.

12. Method according to one of the preceding claims, characterized in that the food product, after the first step and before the second step, is treated with liquid smoke.

13. Device for producing a food product, in particular sausage, which device comprises a first part provided with a co-extrusion device, for forming a food product, such as a sausage, with a core of edible material, such as meat, which is covered on the outer side with a casing, in particular a protein casing, characterized in that the co-extrusion device adjoins a first endless conveyor for conveying the food product, such as the sausage, through a predrying chamber, which first conveyor adjoins both a second endless conveyor for conveying the food product to a climate chamber for fermenting and drying the food product, in this climate chamber, and a third endless conveyor, for transporting the food product through a boiling device, such as a pasteurizer, for cooking the food product, the device comprising means for passing the food product from the first

14. Device according to claim 13, characterized in that the co-extrusion device also adjoins a fourth conveyor for conveying the food product directly from the co-extrusion device to the climate chamber.

15. Device according to claim 13 or 14, characterized in that the second and/or fourth conveyor(s) adjoin(s) a fifth conveyor, for conveying the food product through the climate chamber.

16. Device according to claim 15, characterized in that the fifth conveyor comprises substantially horizontally positioned supports for receiving the food product.

17. Device according to claim 16, characterized in that the supports are designed as receptacles which are open at the top in order to receive the food product.

18. Device according to claim 17, characterized in that the walls of the supports are provided with ventilation openings.

19. Device according to one of claims 15-18, characterized in that the fifth conveyor describes a path which comprises a number of parallel, substantially horizontally oriented parts and at least one vertically oriented section.

20. Device according to claim 19, characterized in that the ends of the horizontal parts are connected via a curved section to a horizontal part which lies below.

21. Device according to one of claims 16-20, characterized in that the supports are rotatably connected to the conveyor.

22. Device according to claim 21, characterized in that the supports can rotate about an equilibrium position via a positive and a negative angular displacement, respectively leading to a first limit position and a second limit position.

23. Device according to claim 21 or 22, characterized in that the supports are provided with a cam, stops being arranged adjacent to the horizontal parts of the path of the conveyor in order to engage on the cam of the supports.

24. Device according to claim 23, characterized in that the stops are designed in such a way that the cams of the supports, in the curved part of the path of the conveyor, are free from contact with the stops.

25. Device according to one of claims 16-24, characterized in that at least one of the supports of the fifth conveyor adjoins the second and/or fourth conveyor, for using this second and/or fourth conveyor to feed the food product to the supports.

26. Device according to claim 25, characterized in that the second and/or fourth conveyor(s), at the location where it/they adjoin(s) the fifth conveyor, run(s) past a ram member, so that the ram member can be used to move the food product which is present on the second and/or fourth conveyor(s) in a direction which is perpendicular to the direction of movement of this/these second and/or fourth conveyor(s) towards the fifth conveyor.

27. A method for producing a food product, comprising:
in a first step, producing a food product with the aid of a co-extrusion, the core being formed from an edible material, which is covered on the outer side with a casing;
thereafter in a second step passing the food product to a predrying chamber;
thereafter in a third step performing one of
(a) fermenting and drying the sausage, and
(b) boiling the sausage; and
thereafter in a fourth step performing one of
(a) passing the food product with the aid of conveyor means to a climate chamber for the purpose of fermenting and drying the food product in this climate chamber, and
(b) passing the food product to a coiling installation for cooking the food product,
wherein the food product is passed through the first, second and fourth steps on a support, and the point of contact between the support and the food product is changed continuously or periodically.

28. The method according to claim 27, wherein the food product is fermented in the climate chamber at a temperature of 20 to 30° C.

29. The method according to claim 28, wherein during the drying the temperature in the climate chamber is reduced in steps from a temperature of 20 to 30° C., to a final temperature of 10 to 20° C.

30. The method according to claim 29, wherein the temperature in the climate chamber is reduced by an average of 4° C. every 24 hours.

31. The method according to claim 27, wherein the relative atmosphere humidity in the climate chamber is set at 85%-95%.

32. The method according to claim 31, wherein the relative atmospheric humidity in the climate chamber is reduced from an initial value of 85%-95%, to a final level of 70%.

33. The method according to claim 32, wherein the relative atmospheric humidity in the climate chamber is reduced by 5% every 24 hours.

34. The method according to claim 27, wherein the food product is received in the climate chamber on a support.

35. The method according to claim 34, wherein the food product is moved in the climate chamber with the aid of the support.

36. The method according to claim 35, wherein the food product is passed through substantially the entire climate space.

37. The method according to claim 27, wherein the food product is cooked, in a second step, at a temperature of 70-80° C.

38. The method according to claim 27, wherein the food product, after the first step and before the second step, is treated with liquid smoke.

39. A device for producing a food product, which device comprises a first part provided with a co-extrusion device, for forming a food product with a core of edible material, which core is covered on the outer side with a casing, wherein the co-extrusion device adjoins a first endless conveyor for conveying the food product through a predrying chamber, which first conveyor adjoins both a second endless conveyor for conveying the food product to a climat chamber for fermenting and drying the food product in this climate chamber, and a third endless conveyor for transporting the food product through a boiling device for cooking the food product, the device comprising means for passing the food product from the first conveyor to either the second or third conveyor.

40. The device according to claim 39, wherein the co-extrusion device also adjoins a fourth conveyor for conveying the food product directly from the co-extrusion device to the climate chamber.

41. The device according to claim 39, wherein at least one of the second and fourth conveyors adjoins a fifth conveyor, for conveying the food product through the climate chamber.

42. The device according to claim 41, wherein the fifth conveyor comprises substantially horizontally positioned supports for receiving the food product.

43. The device according to claim 42, wherein the supports are designed as receptacles which are open at the top in order to receive the food product.

44. The device according to claim 43, wherein the walls of the supports are provided with ventilation openings.

45. The device according to claim 41, wherein the fifth conveyor describes a path which comprises a number of parallel, substantially horizontally oriented parts and a least one vertically oriented section.

46. The device according to claim 45, wherein the ends of the horizontal parts are connected via a curved section to a horizontal part which lies below.

47. The device according to claim 42, wherein the supports are rotatably connected to the conveyor.

48. The device according to claim 47, wherein the supports can rotate about an equilibrium position via a positive and a negative angular displacement, respectively leading to a first limit position and secon limit position.

49. The device according to claim 47, wherein the supports are provided with a cam, stops being arranged adjacent to the horizontal parts of the path of the conveyor in order to engage on the cam of the supports.

50. The device according to claim 49, wherein the stops are designed in such a way that the cams of the supports, in the curved part of the path of the conveyor, are free from contact with the stops.

51. The device according to claim 42, wherein at least one of the supports of the fifth conveyor adjoins at least one of the second and fourth conveyors, for using the at least one of the second and fourth conveyors to feed the food product to the supports.

52. The device according to claim 51, wherein the at least one of the second and fourth conveyors, at the location where it adjoins the fifth conveyor, runs past a ram member, so that the ram member can be used to move the food product which is present on the at least one of the second and fourth conveyors in a direction which is perpendicular to the direction of movement of the at least one of the second and fourth conveyors towards the fifth conveyor.
